(19) United States
(12) Patent Application Publication
(10) Pub. No.: US 2023/0401494 A1
(43) Pub. Date: Dec. 14, 2023

(54) MANAGEMENT METHOD, MANAGEMENT DEVICE, AND MANAGEMENT PROGRAM FOR CAR RENTAL SERVICE

(71) Applicant: TOYOTA JIDOSHA KABUSHIKI KAISHA, Toyota-shi (JP)

(72) Inventors: Shun OTA, Susono-shi (JP); Taro HASEGAWA, Toyota-shi (JP); Tomoya TAKEDA, Toyota-shi (JP); Yuka NISHIYAMA, Toyota-shi (JP); Hiroya CHIBA, Fuji-shi (JP); Tatsuya SUGANO, Sunto-gun (JP); Taizo MASUDA, Yokohama-shi (JP)

(73) Assignee: TOYOTA JIDOSHA KABUSHIKI KAISHA, Toyota-shi (JP)

(21) Appl. No.: 18/192,035

(22) Filed: Mar. 29, 2023

(30) Foreign Application Priority Data
Jun. 13, 2022 (JP) 2022-095191

(51) Int. Cl. G06Q 10/02; G06V 20/56; G06V 20/59

(52) U.S. Cl. CPC G06Q 10/02; G06V 20/56; G06V 20/59

(57) ABSTRACT

A method for managing a car rental service for renting a vehicle in response to a rental request from a user is provided. The method includes the steps of: acquiring image data of at least one of the surroundings and the interior of the vehicle acquired using a camera mounted on the vehicle; and processing the at least one image data acquired during the lending of the vehicle to the user in a reproducible manner at the terminal of the owner when a request for confirmation of the at least one image data is received from the terminal of the owner of the vehicle after the lending of the vehicle to the user.

### CROSS-REFERENCE TO RELATED APPLICATION

This application claims priority to Japanese Patent Application No. 2022-095191 filed on Jun. 13, 2022, incorporated herein by reference in its entirety.

### BACKGROUND

### 1. Technical Field

The present disclosure relates to a method, a device, and a program for managing a car rental service for renting a vehicle in response to a rental request from a user.

### 2. Description of Related Art

Japanese Unexamined Patent Application Publication No. 2006-182234 (JP 2006-182234 A) discloses a camera system for a vehicle. In this conventional camera system, a photographing range of a camera provided in a door mirror of a vehicle is changed according to the door mirror position. Specifically, when the position of the door mirror is in the normal use position, the surroundings of the vehicle are set to the photographing range, and when the position of the door mirror is in the storage position, the interior of the vehicle is set to the photographing range. According to the conventional camera system, it is possible to realize monitoring of the surroundings and the interior of the vehicle with a single camera.

### SUMMARY

Monitoring the surroundings of a vehicle using an in-vehicle camera is important not only from the viewpoint of ensuring the safety of the vehicle while the vehicle is traveling, but also from the viewpoint of preventing mischief such as damaging the vehicle body when the vehicle is parked. Monitoring the interior of a vehicle using an in-vehicle camera is important from the viewpoint of preventing crimes such as stealing valuables and various devices left in the interior of a parked vehicle. In addition, monitoring the interior of a vehicle using an in-vehicle camera is also important from the viewpoint of early detection of an abnormal condition of an occupant of the vehicle.

A car rental service is conceivable in which a vehicle is rented in response to a rental request from a user. In this case, it is assumed that the owner of the vehicle desires to confirm various defects that have occurred during the rental of the vehicle to the user. However, monitoring the surroundings and the interior of the vehicle using the in-vehicle camera during the rental is not appropriate from the viewpoint of protecting the privacy of the user. However, for example, when a scratch of the vehicle body or a dirt in the interior that was not present before the rental is found after the rental, it is detrimental to the owner that the cause thereof cannot be inferred or identified.

One object of the present disclosure is to provide a technology capable of allowing a vehicle owner to infer or identify the causes of various defects that occur during rental of a vehicle to a user in a car rental service.

A first aspect of the present disclosure is a method for managing a car rental service for renting a vehicle in response to a rental request from a user, and has the following features. The method includes: a step of acquiring image data of at least one of surroundings and an interior of the vehicle, the image data being image data acquired using a camera mounted on the vehicle; and a step of causing the image data of the at least one of the surrounding and the interior of the vehicle, the image data being an image data acquired during rental of the vehicle to the user to be reproducible at a terminal of an owner of the vehicle, when a confirmation request of the image data of the at least one of the surrounding and the interior of the vehicle is received from the terminal of the owner after an end of the rental of the vehicle to the user.

A second aspect of the present disclosure is a device for managing a car rental service for renting a vehicle in response to a rental request from a user, and has the following features. The device includes a processor and a memory. The memory stores image data of at least one of surroundings and an interior of the vehicle, the image data being image data acquired using a camera mounted on the vehicle. The processor is configured to process the image data of the at least one of the surroundings and the interior of the vehicle, the image data being image data acquired during rental of the vehicle to the user, such that the image data is reproducible at a terminal of an owner of the vehicle, when a confirmation request of the image data of the at least one of the surroundings and the interior of the vehicle is received from the terminal of the owner after an end of the rental of the vehicle to the user.

A third aspect of the present disclosure is a program for managing a car rental service for renting a vehicle in response to a rental request from a user, and has the following features. The program causes a computer to execute: a process of acquiring image data of at least one of surroundings and an interior of the vehicle, the image data being image data acquired using a camera mounted on the vehicle; and a process of causing the image data of the at least one of the surroundings and the interior of the vehicle, the image data being image data acquired during rental of the vehicle to the user, to be reproducible at a terminal of an owner of the vehicle, when a confirmation request of the image data of the at least one of the surroundings and the interior of the vehicle is received from the terminal of the owner after an end of the rental of the vehicle to the user.

According to the present disclosure, image data of at least one of the surroundings and the interior of the vehicle, which has been acquired during the rental of the vehicle to the user, can be reproduced at the terminal of the owner of the vehicle in response to a confirmation request from the owner. Therefore, it is possible for the owner of the vehicle to infer or identify the causes of various defects that occur during the rental of the vehicle to the user.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram for explaining an outline of a car rental service;

FIG. 2 is a block diagram illustrating a configuration example of a car rental service system;

FIG. 3 is a flowchart illustrating a flow of processing by a terminal (processor) of a vehicle, particularly related to an embodiment; and

FIG. 4 is a flowchart for describing a flow of processing by the management server (processor), which is particularly related to the embodiment.

### DETAILED DESCRIPTION OF EMBODIMENTS

Hereinafter, a car rental service management method, a management device, and a management program according to an embodiment of the present disclosure will be described with reference to the drawings. In each drawing, the same or corresponding portions are denoted by the same reference signs and the description thereof will be simplified or omitted.

1. Summary of the Embodiment

1-1. Car Rental Service

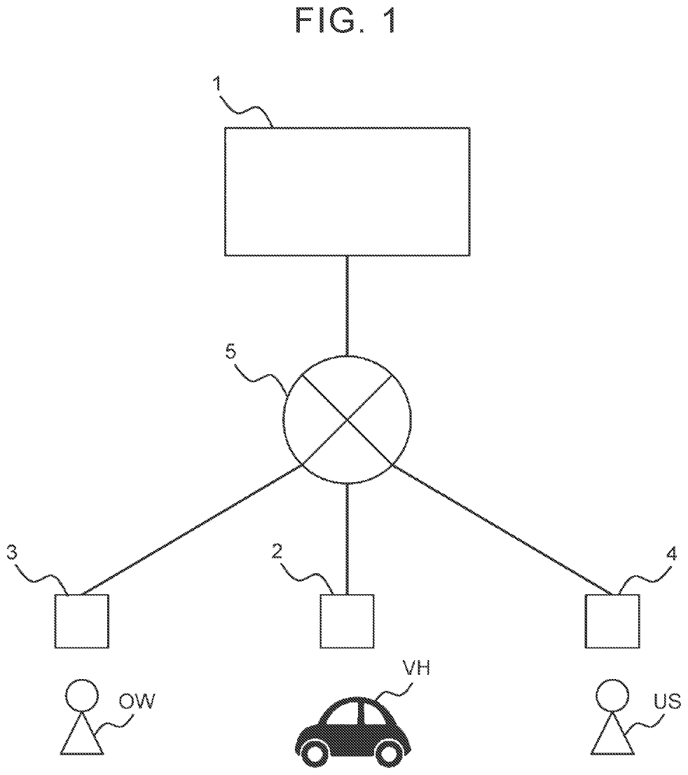

FIG. 1 is a diagram illustrating an outline of a car rental service. The car rental service is a service in which a vehicle VH of an owner OW who is a person or a corporation is lent to a user US who wishes to temporarily use the vehicle. When the use condition desired by the user US matches the rental condition desired by the owner OW, the rental of the vehicle VH of the owner OW is performed. Examples of the usage conditions include a date and a time period in which the user US desires to temporarily use the vehicle VH, a position at which use of the vehicle VH is started and ended, specifications of a vehicle VH that desires to be used (for example, vehicle rating, occupant capacity, and maximum loading capacity), and main applications of the vehicle VH being used. Examples of the lending terms include a date and a time period during which the owner OW can lend the vehicle VH, and a main use of the vehicle VH being lent.

The management server 1 illustrated in FIG. 1 manages a car rental service. As an example of managing the car rental service, matching between the user US and the owner OW (vehicle VH) is exemplified. The management of the car rental service also includes management of user US, owner OW, and vehicle VH. In order to perform such control, the management server 1 communicates with the terminal 2 of the vehicle VH, the terminal 3 of the owner OW, and the terminal 4 of the user US via the network 5. Hereinafter, for convenience of explanation, the terminal 2 of the vehicle VH is also referred to as “vehicle terminal 2”, the terminal 3 of the owner OW is also referred to as “owner terminal 3”, and the terminal 4 of the user US is also referred to as “user terminal 4”.

The management of the car rental service also includes the management of the image data acquired by the camera of the vehicle VH during the rental to the user US. Examples of the camera include a camera that captures an image of the surroundings (front, side, and rear) of the vehicle VH, and a camera that captures an image of the interior of the vehicle VH. Hereinafter, for convenience of explanation, image data acquired by a camera that captures an image of the surroundings of the vehicle VH is also referred to as “surrounding image data IMS”. Image data acquired by a camera that captures an image of the interior of the vehicle VH is also referred to as “indoor image data IMR”. The surrounding image data IMS and the indoor image data IMR are typically moving image data.

The surrounding image data IMS and the indoor image data IMR are acquired not only during the operation of the vehicle VH but also during the non-operation of the vehicle VH. These images are also recorded in a predetermined storage device of the vehicle VH. However, these images acquired during lending to the user US are recorded so that the owner OW cannot freely view them from the viewpoint of protecting the privacy of the user US. These pieces of image data are also transmitted to the management server 1 through the network 5 and recorded in a predetermined storage device of the management server 1. It should be noted that these images recorded in the storage device of the vehicle VH are preferably deleted after being transmitted to the management server 1.

1-2. Feature of Embodiment

In the embodiment, when the management server 1 receives a lending request from the user US (the user terminal 4), a vehicle VH in which a usage condition desired by the user US matches a lending condition desired by the owner OW is selected. The selected vehicle VH is transmitted from the management server 1 to the user terminal 4. When the use of the vehicle VH is started, the user US authenticates with the vehicle VH using, for example, short-range communication or the like. This allows the user US to use the vehicle VH. When the use of the vehicle VH is terminated, the user US authenticates with the vehicle VH.

While the authentication of the user US by the vehicle VH is valid, that is, during the use of the vehicle VH (that is, during the rental of the vehicle VH) by the user US, the surrounding image data IMS and the indoor image data IMR are acquired. These images acquired during the use of the vehicle VH by the user US are transmitted from the vehicle VH (vehicle terminal 2) to the management servers 1. Transmission of the image data from the vehicle VH to the management server 1 is performed, for example, when the communication condition is satisfied. The transmission of the image data may be performed at all times or periodically.

The surrounding image data IMS and the indoor image data IMR received by the management server 1 are stored in the storage device of the management server 1 for a predetermined period after the use of the vehicle VH by the user US (that is, after the rental of the vehicle VH). When the management server 1 receives a confirmation request from the owner OW (the owner terminal 3) for at least one of these pieces of image data, the management server 1 processes the image data to be subjected to the confirmation request stored in the storage device of the management server 1 so as to be reproducible at the owner terminal 3. Hereinafter, for convenience of explanation, the image data to be checked is also referred to as “confirmation target data IMC”.

As a process of making the confirmation target data IMC reproducible in the owner terminal 3, a process of transmitting the confirmation target data IMC to the owner terminal 3 is exemplified. When the transmitted confirmation target data IMC is reproduced by the owner terminal 3, the owner OW can confirm the confirmation target data IMC. Another example is a streaming process in which the reproduction of the image data in the owner terminal 3 is performed simultaneously with the download. According to the streaming process, the confirmation target data IMC is not recorded so as to be accessible to the temporary folders of the owner terminal 3. Therefore, while protecting the privacy of the user US, the user can respond to a confirmation request from the owner OW (or an agent of the owner OW).

The fact that there is a request for verification from the owner OW (or an agent of the owner OW) is considered to be a situation in which the owner OW (or an agent) who finds a scratch on the vehicle body or a dirt in the interior of the vehicle after lending out the vehicle body which was not prior to the lending out of the vehicle VH makes an inquiry regarding this as the management server 1. In this regard, according to the embodiment, the confirmation target data IMC can be reproduced by the owner terminal 3. Thus, the owner OW (or proxy) who has found a scratch on the vehicle body or a dirt in the room can infer or identify the reason for this.

In the embodiment, it is desirable that the management server 1 performs a process of recognizing a target object included in the image data prior to processing of the confirmation target data IMC by the owner terminal 3 so as to be reproducible.

When the confirmation target data IMC is the surrounding image data IMS, for example, the following process is preferably performed. In the recognition process for the surrounding image-data IMS, it is desirable to determine whether or not an abnormal behavior pattern of a dynamic target (for example, a person, a bicycle, an automobile, or a flying object) approaching the vehicle VH is recognized. When the abnormal behavior pattern of the dynamic target is recognized, it is desirable to add the mark data to the surrounding-image data IMS including the dynamic target. Examples of the abnormal behavior pattern of the dynamic target include touch to the vehicle VH by the dynamic target, motion of a person orbiting around the vehicle VH, and motion of a person looking into the interior of the vehicle VH many times.

When the confirmation target data IMC is an indoor image data IMR, for example, it is desirable to perform the following process. In the process of recognizing an indoor image-data IMR, it is desirable to determine whether an abnormal behavior pattern of an indoor dynamic target (for example, a human or an animal) or a movement of a static target (for example, a baggage) in a room is recognized. When the abnormal behavior pattern of the dynamic target or the movement of the static target is recognized, it is desirable to add the mark data to the indoor image data IMR including the dynamic target or the static target. An example of the abnormal behavior pattern of the dynamic target is an operation of an occupant such as strongly pressing or strongly hitting the operating device of the vehicle VH.

When the landmark data is added to the confirmation target data IMC, it is desirable that the management server 1 processes the landmark data so as to be recognizable by the owner terminal 3 when the confirmation target data IMC is reproduced. As an example of processing of enabling recognition of the landmark data, in the above-described processing for streaming, processing of superimposing an image indicating the landmark on the image data is exemplified. Since the landmark data is processed in the owner terminal 3 so as to be recognizable, it is possible to shorten the period required for checking the image data by the owner OW. It can also help the owner OW to infer or identify the source of body damage or indoor contamination.

2. Sample System Configuration

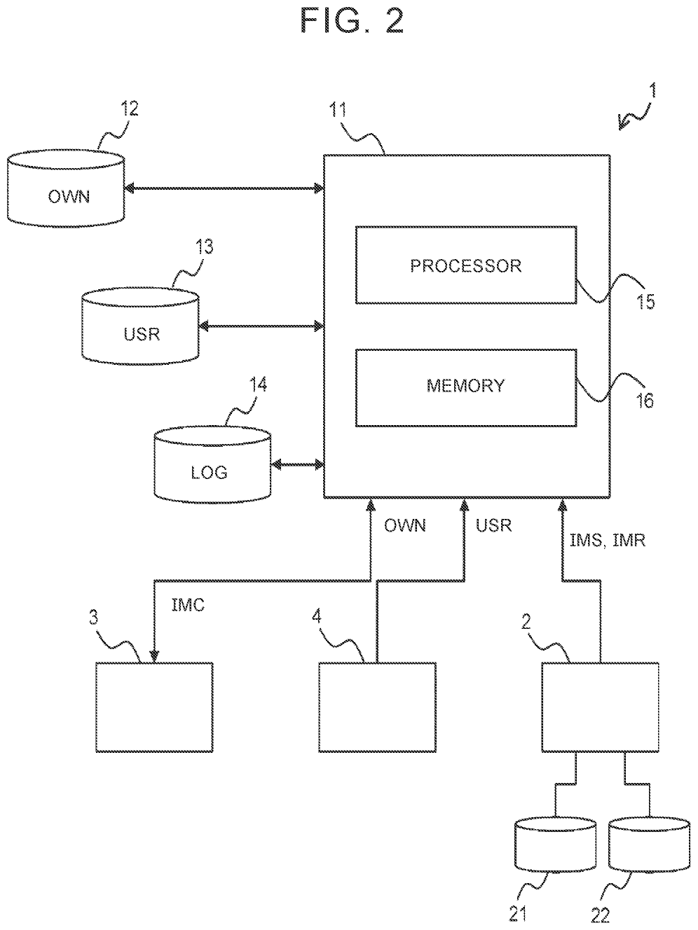

FIG. 2 is a block diagram illustrating a configuration example of a car rental service system. The configuration example illustrated in FIG. 2 includes a management server 1, a vehicle terminal 2, an owner terminal 3, and a user terminal 4. As described in the description of FIG. 1, the management server 1 communicates with the vehicle terminal 2, the owner terminal 3, and the user terminal 4.

In the embodiment illustrated in FIG. 2, the management server 1 includes a data processing device 11, an owner DB (database) 12, a user DB 13, and a log DB 14. These databases and the data processing device 11 are connected by a predetermined network.

The data processing device 11 comprises at least one processor 15 and at least one memory 16. The processor 15 includes a Central Processing Unit (CPU). The memory 16 is a volatile memory such as a DDR memory, and performs expansion of various programs used by the processor 15 and temporary storage of various types of data. The various programs used by the processor 15 include a management program according to the embodiment. The various types of data used by the processor 15 include data stored in a data base such as an owner DB 12.

The owner DB 12 stores data of the owner OW that provides the vehicle VH to the car rental service (hereinafter, also referred to as “owner data OWN”). Examples of the owner data OWN include identification data. The identification data is data for identifying the owner OW. The identification data is registered by the owner OW, for example, when the vehicle VH is registered in the car rental service. Examples of the identification data include common data such as the name, age, gender, address, and contact address of the owner OW. The identification data also includes identification data of a vehicle VH owned by the owner OW (for example, a vehicle registration number and a vehicle body identification number).

The owner data OWN exemplifies rental terms data of the vehicle VH. Examples of lending terms include the date and time period during which the owner OW can lend out the vehicle VH, and the main use of the vehicle VH being lent out. Conditions that the owner OW separately desires (e.g., indoor smoking cessation, pets cessation) may be added to the lending conditions.

The user DB 13 stores data of a user US who desires to temporarily use the vehicle VH (hereinafter, also referred to as “user data USR”). Examples of the user data USR include identification data. The identification data is data for identifying the user US. For example, when the car rental service is used, the identification data is registered by the user US. Examples of the identification data include common data such as the name, age, gender, address, and contact address of the user US. Identification data also includes data of operating qualification categories owned by the owner OW (e.g., large, medium, quasi-medium, and normal).

The user DB 13 is exemplified by usage criteria of the vehicle VH. Examples of the usage conditions include a date and a time zone in which the user US desires to temporarily use the vehicle VH, a position at which use of the vehicle VH is started and ended, specifications of a vehicle VH that desires to be used, and a main use of the vehicle VH in use. Conditions that the user US separately desires (e.g., indoor smoking, companion riding) may be added to the usage conditions.

The log DB 14 is an exemplary predetermined storage device included in the management server 1. The log DB 14 stores log data LOG recorded during lending of the vehicle VH. The log data LOG is stored in a manner corresponding to the identification data of the vehicle VH. The log data LOG includes surrounding image data IMS and indoor image data IMR acquired during use of the vehicle VH by the user US. In addition to the identification data of the vehicle VH, the log data LOG may be stored corresponding to the identification data of the user US using the vehicle VH.

The log data LOG may include data other than the surrounding image data IMS and the indoor image data IMR. Examples of the data other than the image data include ambient sound data and indoor sound data acquired during use of the vehicle VH by the user US. The ambient sound data is sound data acquired by a microphone that records the ambient sound of the vehicle VH. The indoor sound data is sound data acquired by a microphone that records the indoor sound of the vehicle VH. It is expected that the owner OW who has found a scratch on the vehicle body or a dirt in the room will help to infer or identify the reason for this.

The vehicle terminal 2 is a terminal mounted on the vehicle VH. The vehicle terminal 2 includes at least one processor and at least one memory. The basic configuration of the vehicle terminal 2 is the same as that of the data processing device 11. In the example illustrated in FIG. 2, the storage devices 21 and 22 are connected to the vehicle terminal 2. The storage devices 21 and 22 are devices for recording surrounding image data IMS and indoor image data IMR. The storage devices 21 and 22 are exemplary predetermined storage devices included in the vehicle VH. The storage device 21 stores, for example, these images recorded during lending of the vehicle VH. The storage device 22 stores these images recorded during non-lending of the vehicle VH (e.g., during use of the vehicle VH by the owner OW).

When the ambient sound data and the indoor sound data are acquired, these sound data may be recorded in the storage devices 21 and 22. In this case, the storage device 21 stores, for example, these pieces of sound data recorded during lending of the vehicle VH. The storage device 22 stores the sound data recorded during the non-lending of the vehicle VH.

The owner terminal 3 is a terminal for the owner OW to communicate with the management server 1. The user terminal 4 is a terminal for the user US to communicate with the management server 1. The owner terminal 3 and the user terminal 4 are, for example, portable terminals such as tablets and smartphones. The basic configuration of the owner terminal 3 and the user terminal 4 is the same as that of the data processing device 11.

3. Data Processing Example

3-1. Processing Example in a Vehicle Terminal

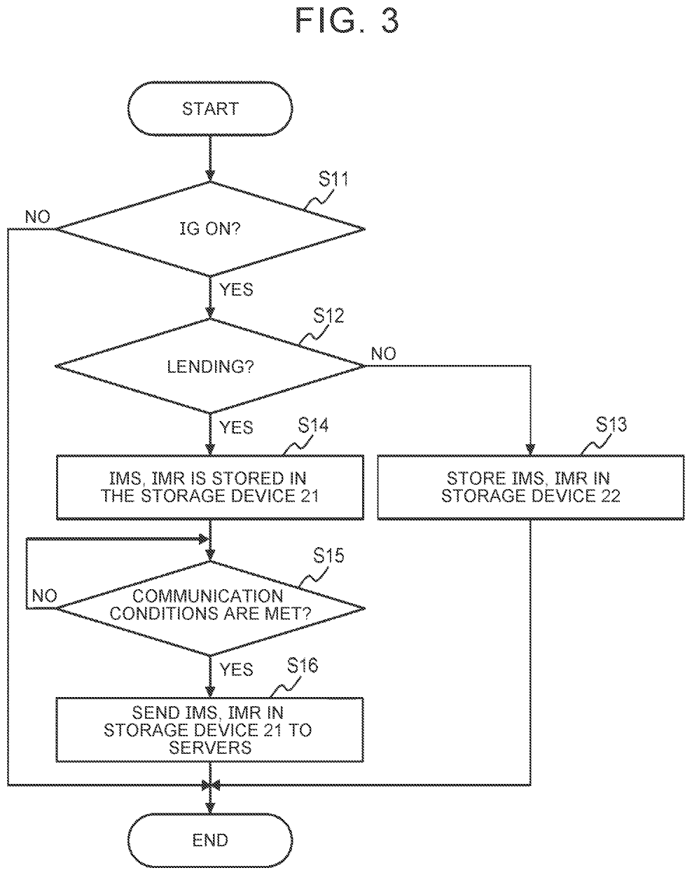

FIG. 3 is a flowchart for explaining a flow of processing by the processor of the vehicle terminal 2, which is particularly related to the embodiment. The flowchart illustrated in FIG. 3 is repeatedly executed at a predetermined control cycle, for example.

In the routine illustrated in FIG. 3, first, it is determined whether or not the ignition switch (IG) is in an activated state (step S11). The ignition switch is a switch for operating the power supply circuitry of the vehicle VH, and is operated by an occupant (for example, an owner OW) of the vehicle VH and a user US. When the vehicle VH is configured to be remotely operable, the ignition switch may be remotely operable by an operator of the vehicle VH.

If the determination result of the step S11 is affirmative, it is determined whether or not the vehicle VH is being lent (step S12). Whether or not the vehicle VH is being rented can be determined, for example, based on the authentication performed when the user US starts using the vehicle VH or when the user US ends using the vehicle VH. In another embodiment, it is determined whether the vehicle VH is being rented based on the date and time of use of the vehicle VH by the user US. It is to be noted that in this embodiment, it is assumed that the user US has previously received the date of use and the time zone from the management server 1 by the vehicle terminal 2.

When the determination result of the step S12 is negative, the surrounding image data IMS and the indoor image data IMR are stored in the storage device 22 (step S13). When the ambient sound data and the indoor sound data are acquired, the storage device 22 may store the sound data recorded during the non-lending of the vehicle VH. When the determination result of the step S12 is affirmative, the surrounding image data IMS and the indoor image data IMR are stored in the storage device 21 (step S14). When the ambient sound data and the indoor sound data are acquired, the storage device 21 may store the sound data recorded during lending of the vehicle VH.

Following the process of step S14, it is determined whether or not the communication condition is satisfied (step S15). As the communication condition, for example, it is exemplified that the communication level of the vehicle terminal 2 is equal to or higher than a threshold. The communication level can be calculated based on, for example, a reception speed of data from a base station on the network 5 to which the vehicle terminal 2 is currently connected, a reception delay time of data, a fluctuation (jitter) of the reception delay time, and the like. The process of S15 of steps is repeated until a positive determination is obtained.

When the determination result of the step S15 is affirmative, the surrounding image data IMS and the indoor image data IMR stored in the storage device 21 are transmitted to the management server 1 (step S16). When the ambient sound data and the indoor sound data are stored in the storage device 21, these sound data may be transmitted to the management server 1.

3-2. Processing Example in the Management Server

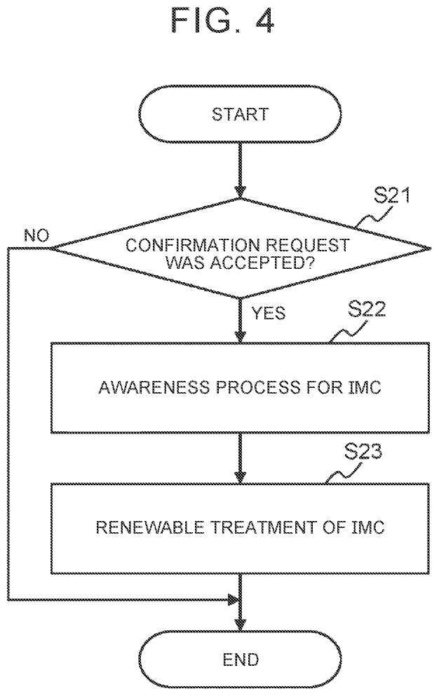

FIG. 4 is a flowchart for describing a flow of processing by the processor of the management server 1 that is particularly related to the embodiment. The flowchart illustrated in FIG. 4 is repeatedly executed at a predetermined control cycle, for example.

In the routine illustrated in FIG. 4, first, it is determined whether or not a confirmation request has been received from the owner terminal 3 (step S21). The confirmation request includes, for example, identification data of the owner OW, data of a date and a time zone in which the owner OW desires to confirm, and a type of the confirmation target data IMC. The type of the confirmation target data IMC is image data of at least one of the surrounding image data IMS and the indoor image data IMR. The type of the confirmation target data IMC may include detailed data such as the position of the vehicle body that needs to be confirmed (for example, front, side, and rear), and the position of the room that needs to be confirmed (for example, the driver's seat and the occupant's seat other than the driver's seat).

When the determination result of the step S21 is affirmative, a process of recognizing the confirmation target data IMC is performed (step S22). Note that the process of step S22 may be skipped and the process of step S23 may be performed. The object of the recognition process in the step S22 is the confirmation target data IMC included in the confirmation request acquired in the process of the step S21. In the recognition process, for example, the target object included in the confirmation target data IMC is recognized by using the machine learning model. Note that a known method can be applied to the recognition of a target object using a machine learning model.

In the recognition process for the surrounding image data IMS, landmark data is added to the surrounding image data IMS including the dynamic target when the abnormal behavior pattern of the dynamic target (for example, a person, a bicycle, a car, or a flying object) approaching the vehicle VH is recognized. In a process of recognizing an indoor image data IMR, when an abnormal behavior pattern of a dynamic target (for example, a human or an animal) in a room or a movement of a static target (for example, a package) in a room is recognized, landmark data is given to an indoor image data IMR including the dynamic target or the static target.

Following the process of step S22, the confirmation target data IMC is reproducibly processed (step S23). An example of the process of making it reproducible is a process of transmitting the confirmation target data IMC to the owner terminal 3. Another example is a streaming process in which the owner terminal 3 plays back the confirmation target data IMC at the same time as downloading.

When the landmark data is added in the process of the step S22, the landmark data is processed so as to be recognizable by the owner terminal 3. An example of the process of making the landmark data recognizable is a process of transmitting the landmark data to the owner terminal 3. Another example is a process of superimposing an image indicating a landmark on image data in a process for streaming.

When the ambient sound data and the indoor sound data are stored in the storage device 21, in the process of the step S23, the sound data corresponding to the confirmation target data IMC may be processed so as to be reproducible at the same time as the confirmation target data IMC. The sound data corresponding to the confirmation target data IMC is sound data of at least one of ambient sound data and indoor sound data. An example of a process of making sound data reproducible is the same as an example of a process of making the confirmation target data IMC reproducible. The process of making the sound-data reproducible can help the owner OW to infer or identify the source of the vehicle body damage or indoor contamination.

4. Effect

According to the embodiment described above, the confirmation target data IMC can be reproduced in the owner terminal 3 in response to a confirmation request from the owner OW (or the proxy). Thus, the owner OW (or proxy) who has found a scratch on the vehicle body or a dirt in the room can infer or identify the reason for this.

What is claimed is:

1. A management method for a car rental service for renting a vehicle in response to a rental request from a user, the management method comprising:
a step of acquiring image data of at least one of surroundings and an interior of the vehicle, the image data being image data acquired using a camera mounted on the vehicle; and
a step of processing the image data of the at least one of the surroundings and the interior of the vehicle, the image data being image data acquired during rental of the vehicle to the user, such that the image data is reproducible at a terminal of an owner of the vehicle, when a confirmation request of the image data of the at least one of the surroundings and the interior of the vehicle is received from the terminal of the owner after an end of the rental of the vehicle to the user.

2. The management method according to claim 1, wherein:
the image data of the at least one of the surroundings and the interior of the vehicle is surrounding image data of the vehicle; and
the management method further includes
a step of performing a recognition process of a target included in the surrounding image data acquired during the rental of the vehicle to the user, before the surrounding image data is processed to be reproducible at the terminal of the owner, when a confirmation request of the surrounding image data is received from the terminal of the owner,
a step of giving marker data to the surrounding image data in which a recognized dynamic target is contained, when an unusual behavior pattern of the dynamic target approaching the vehicle is recognized in the recognition process, and
a step of processing the marker data such that the marker data is recognizable at the terminal of the owner when the surrounding image data is reproduced at the terminal of the owner.

3. The management method according to claim 1, wherein:
the image data of the at least one of the surroundings and the interior of the vehicle is interior image data of the vehicle; and
the management method further includes
a step of performing a recognition process of a target included in the interior image data acquired during the rental of the vehicle to the user, before the interior image data is processed to be reproducible at the terminal of the owner, when a confirmation request of the interior image data is received from the terminal of the owner,
a step of giving marker data to the interior image data in which a recognized dynamic target or a recognized static target is contained, when an unusual behavior pattern of the dynamic target in the interior of the vehicle is recognized in the recognition process or when movement of the static target in the interior of the vehicle is recognized in the recognition process, and
a step of processing the marker data such that the marker data is recognizable at the terminal of the owner when the interior image data is reproduced at the terminal of the owner.

4. The management method according to claim 1, further comprising:
a step of acquiring sound data of the at least one of the surroundings and the interior of the vehicle, the sound data being sound data acquired using a microphone mounted on the vehicle; and
a step of processing the sound data of the at least one of the surroundings and the interior of the vehicle, the sound data being sound data acquired using the microphone during the rental of the vehicle to the user, such that the sound data is reproducible at the terminal of the owner, when a confirmation request of the sound data of the at least one of the surroundings and the interior of the vehicle is received from the terminal of the owner after the end of the rental of the vehicle to the user.

5. A management device for a car rental service for renting a vehicle in response to a rental request from a user, the management device comprising:
a processor; and
a memory storing image data of at least one of surroundings and an interior of the vehicle, the image data being image data acquired using a camera mounted on the vehicle, wherein the processor is configured to process the image data of the at least one of the surroundings and the interior of the vehicle, the image data being image data acquired during rental of the vehicle to the user, such that the image data is reproducible at a terminal of an owner of the vehicle, when a confirmation request of the image data of the at least one of the surroundings and the interior of the vehicle is received from the terminal of the owner after an end of the rental of the vehicle to the user.

6. A management program for a car rental service for renting a vehicle in response to a rental request from a user, the management program causing a computer to execute:
a process of acquiring image data of at least one of surroundings and an interior of the vehicle, the image data being image data acquired using a camera mounted on the vehicle; and
a process of causing the image data of the at least one of the surroundings and the interior of the vehicle, the image data being image data acquired during rental of the vehicle to the user, to be reproducible at a terminal of an owner of the vehicle, when a confirmation request of the image data of the at least one of the surroundings and the interior of the vehicle is received from the terminal of the owner after an end of the rental of the vehicle to the user.
